(19) United States
(12) Patent Application Publication
(10) Pub. No.: US 2009/0254305 A1
(43) Pub. Date: Oct. 8, 2009

(54) METHOD OF EVALUATING OPTICAL PERFORMANCE OF OPTICAL SYSTEM

(75) Inventor: Ryo Koizumi, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/419,182

(22) Filed: Apr. 6, 2009

(30) Foreign Application Priority Data
Apr. 8, 2008 (JP) 2008-100864

(51) Int. Cl. G01M 11/02

(52) U.S. Cl. 702/167

(57) ABSTRACT

A method of evaluating an optical performance of an optical system comprises a locating step of locating a plurality of circular regions in an evaluated region on an optical element included in the optical system, a fitting step of fitting a polynomial to surface shape data representing a surface shape of the optical element in each of the plurality of circular regions, and a calculation step of calculating the optical performance of the optical system based on the fitting result obtained in the fitting step in each of the plurality of circular regions.

### BACKGROUND OF THE INVENTION

1. Field of the Invention

The present invention relates to a method of evaluating the optical performance of an optical system, and techniques associated with the same.

2. Description of the Related Art

Along with the recent increase in the packing density of semiconductor devices, the wavelength of light for use in exposure is shortening, and the NA of the projection optical system is increasing.

To meet the demands for an increase in the NA of the projection optical system, an immersion exposure apparatus in which the space between the substrate and the lowermost surface of the projection optical system is filled with a liquid has arrived on the market. In order to attain NA>1, the immersion exposure apparatus is configured such that the space between the substrate and the final lens of the projection optical system is filled with a substance (pure water in an ArF exposure apparatus) having a refractive index higher than 1. It is a common practice to use a catadioptric system as the projection optical system of the current leading-edge immersion exposure apparatus which attains NA>1.2 (“A Hyper-NA Projection Lens for ArF Immersion Exposure Tool”, Nikon Corporation, Proc. of SPIE Vol. 6154). This catadioptric system is often configured by forming holes in its constituent optical elements such as mirrors and lenses or by using meniscus optical elements (Japanese Patent Laid-Open No. 06-242379).

To increase the packing density of semiconductor devices, that is, to micropattern them, it is also important to ensure the precisions of optical elements which constitute the projection optical system. To do this, techniques of evaluating the surface shape of an optical element are used. The surface shape evaluation can include a step of measuring a surface shape, and a step of fitting a Zernike polynomial to the surface shape (Japanese Patent Laid-Open No. 2005-116852).

An error of the surface shape of the optical element accounts for deterioration in the optical performance of the projection optical system included in the exposure apparatus mentioned above. To keep up with the recent demands for a reduction in the aberration of the projection optical system, a surface shape error evaluation method which can precisely predict the optical performance of the projection optical system and precisely process the optical element to correct its surface error is necessary in a process of polishing the optical element.

Conventionally, circular optical elements are often included in the projection optical system. However, to configure a compact catadioptric system, holes are often formed in its constituent optical elements such as mirrors and lenses or meniscus optical elements are often used.

When the surface shape of a circular measured object is measured, its entire surface is measured at once, and a Zernike polynomial is commonly used to analyze and evaluate the measurement result.

In contrast, when the surface shape of a noncircular measured object is evaluated using a Zernike polynomial, even if data including errors between individual measurement apparatuses in only a small region relative to the evaluated region are used, Zernike coefficients having errors amplified are output as a consequence.

This is because the Zernike polynomial is a function orthogonalized only in a circular region. More specifically, when the Zernike polynomial is fitted to a non-orthogonalized (noncircular) region, non-orthogonalized functions cancel errors between individual measurement apparatuses in a small region. Therefore, each Zernike coefficient has a value larger than necessary.

There is also a general method of predicting the optical performance in, for example, an exposure apparatus. In this method, the optical performance is obtained by linear calculation of Zernike coefficients describing the surface shape, and the sensitivities, calculated by optical computing, of the optical performance to the Zernike coefficients describing the surface shape. In this case, when the optical performance is calculated using Zernike coefficients obtained in a noncircular region as well, it is impossible to precisely predict the optical performance because the Zernike coefficients themselves include large errors.

### SUMMARY OF THE INVENTION

It is an object of the present invention to provide a method of precisely evaluating, for example, the optical performance of an optical system, and techniques associated with the same.

One of the aspect of the present invention provides a method of evaluating an optical performance of an optical system comprising a locating step of locating a plurality of circular regions in an evaluated region on an optical element included in the optical system, a fitting step of fitting a polynomial to surface shape data representing a surface shape of the optical element in each of the plurality of circular regions, and a calculation step of calculating the optical performance of the optical system based on the fitting result obtained in the fitting step in each of the plurality of circular regions.

Further features of the present invention will become apparent from the following description of exemplary embodiments with reference to the attached drawings.

### BRIEF DESCRIPTION OF THE DRAWINGS

FIG. 1 is a view showing the schematic arrangement of a surface shape evaluation apparatus and an optical system evaluation apparatus including it according to a preferred embodiment of the present invention;

FIG. 2 is a view exemplifying the schematic arrangement of an exposure apparatus including an optical element as the measured object;

FIG. 3A is a view visually representing surface shape data in the evaluated region on the optical element measured by a measuring apparatus;

FIG. 3B is a view visually representing the surface shape data in the evaluated region on the optical element measured by the measuring apparatus;

FIG. 3C is a chart showing one section in FIGS. 3A and 3B;

FIG. 4 is a view showing a simulation example of a state in which measurement errors have occurred in partial regions of the surface shape data;

FIG. 5A is a graph showing the results of fitting the 1st to 16th terms of the 1st to 100th terms of a Zernike polynomial to data 1 and 2;

FIG. 5B is a graph showing the differences between data 1 and 2 for the 1st to 16th terms shown in FIG. 5A;

FIG. 6 is a table exemplifying the results of calculating the optical performances of a projection optical system including the optical element using Zernike coefficients describing the surface shape of the optical element;

FIG. 7 is a flowchart illustrating an optical system evaluation method according to a preferred embodiment of the present invention;

FIG. 8A is a table showing an example of the fitting results (Zernike coefficients) of a Zernike polynomial, which are obtained in step S30;

FIG. 8B is a table showing an example of the optical performances of the projection optical system, which are obtained in step S40;

FIG. 8C is a table showing the results of evaluating the optical performances at 27 points, which are shown in FIG. 8B;

FIG. 9 is a flowchart illustrating a processing plan creation method for an optical element according to a preferred embodiment of the present invention;

FIG. 10A is a two-dimensional map exemplifying the processing amount averaged in step S130;

FIG. 10B is a two-dimensional map illustrating the processing amount smoothed in step S140;

FIG. 10C is a chart showing one section of the processing amount averaged in step S130;

FIG. 10D is a chart showing one section of the processing amount smoothed in step S130; and

FIG. 11 is a table exemplifying the allowable values and predicted values of the optical performances of an optical system.

### DESCRIPTION OF THE EMBODIMENTS

Preferred embodiments of the present invention will be described below with reference to the accompanying drawings.

FIG. 1 is a view showing the schematic arrangement of a surface shape evaluation apparatus and an optical system evaluation apparatus including it according to a preferred embodiment of the present invention. A surface shape evaluation apparatus 100 according to the preferred embodiment of the present invention includes a measurement apparatus 2 for measuring the surface shape of an optical element 1 as the measured object, and an arithmetic processing unit 3 for arithmetically processing and evaluating the surface shape data provided by the measurement apparatus 2. The measurement apparatus 2 may be, for example, a noncontact measurement apparatus such as an interferometer or a measurement apparatus which traces the surface of the measured object by a probe.

The optical system evaluation apparatus according to the preferred embodiment of the present invention includes the surface shape evaluation apparatus 100 and an information processing apparatus 200. The information processing apparatus 200 controls the surface shape evaluation apparatus 100, and evaluates the optical performance of an optical system including the optical element 1 based on the evaluation result of the optical element 1 provided by the surface shape evaluation apparatus 100. The information processing apparatus 200 can be configured by, for example, installing a computer program for executing an optical system evaluation method on a computer such as a personal computer. The information processing apparatus 200 may execute all or part of the process by the arithmetic processing unit 3.

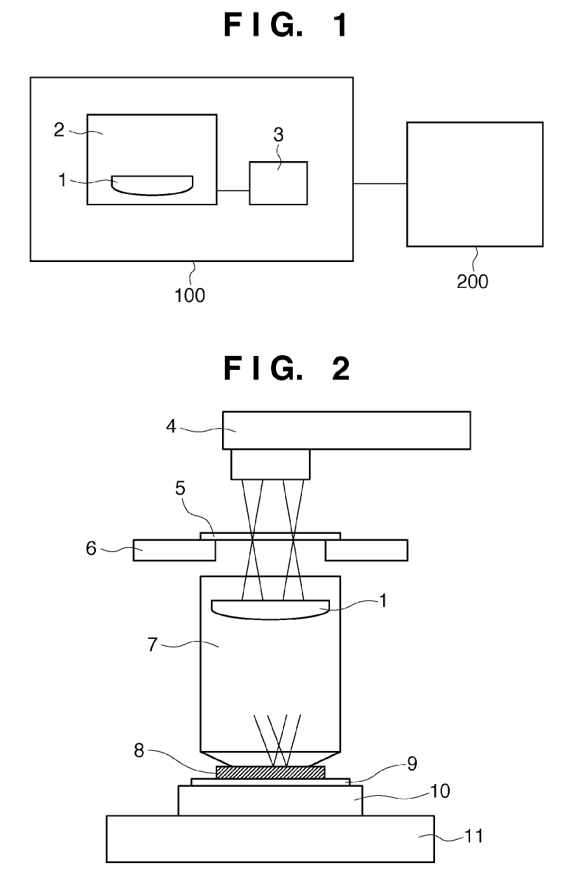

FIG. 2 is a view exemplifying the schematic arrangement of an exposure apparatus including the optical element 1 as the measured object. In this example, the exposure apparatus is configured as an immersion exposure apparatus which projects the pattern of an original 5 onto a substrate 9 by filling the space between a projection optical system 7 and the substrate 9 with a liquid 8. The optical element 1 as the measured object is included in, for example, the projection optical system 7.

The original 5 is held by an original stage 6 and illuminated with exposure light emitted by an illumination system 4. The exposure light from the original 5 enters the projection optical system 7. The exposure light beams coming from arbitrary points on the original 5, that is, arbitrary object points in the projection optical system 7 enter and pass through different positions on the optical element 1 as the measured object.

The light having passed through the optical element 1 passes through other optical elements (if any) of the projection optical system 7, further passes through the liquid 8, and strikes the substrate 9. The pattern surface of the original 5 and the substrate 9 are set to hold a conjugate positional relationship by the projection optical system 7. The substrate 9 is chucked by a substrate chuck 10 mounted on a substrate stage 11. The positions of the substrate stage 11 and original stage 6 are controlled by a position control system including an interferometer and driving mechanism. When the exposure apparatus in this embodiment is configured as a scanning exposure apparatus, the substrate stage 11 and original stage 6 are scanned and driven at a speed matching the magnification of the projection optical system 7.

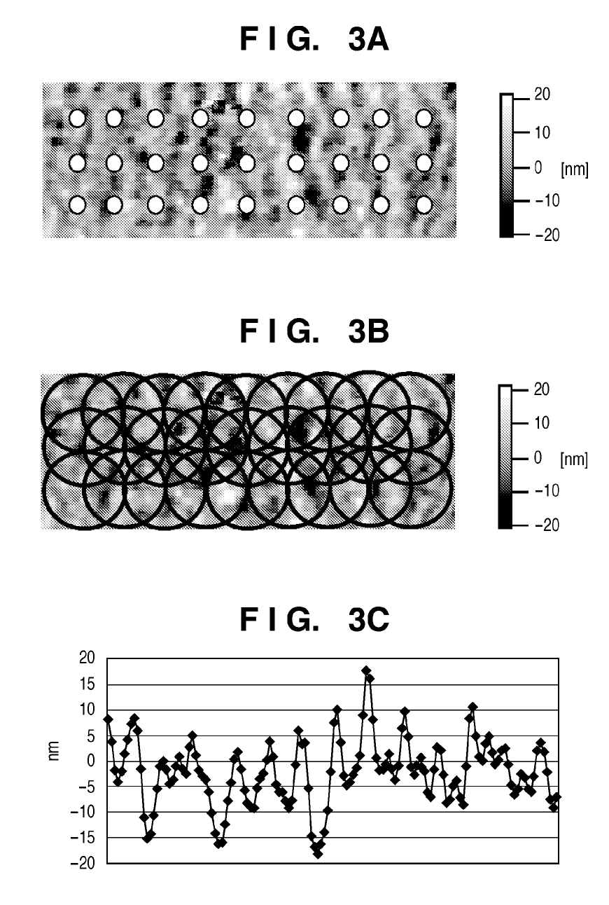

The optical element 1 as the measured object need only cover the light beam effective diameter in the projection optical system 7, so it can have not a circular shape but a rectangular shape from the viewpoint of the configuration of the projection optical system 7. FIGS. 3A and 3B are views visually representing surface shape data in the evaluated region on the optical element 1, which are measured by the measurement apparatus 2. Twenty-seven white circles in FIG. 3A indicate the centers of regions which receive the light beams from 27 object points defined in the object plane of the projection optical system 7. Twenty-seven circles in FIG. 3B indicate the regions which receive the light beams from the 27 object points defined in the object plane of the projection optical system 7. The circles in FIG. 3B indicate the evaluated region on the optical element 1. FIG. 3C shows one section in FIGS. 3A and 3B.

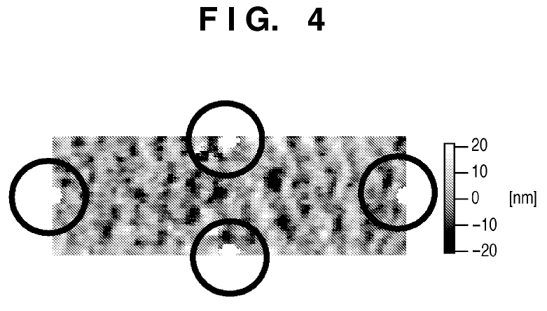

FIG. 4 shows a simulation example of a state in which measurement errors have occurred in partial regions of the surface shape data. Note that four data defect regions are intentionally located assuming a data defect as a measurement error. The surface shape data shown in FIGS. 3A and 3B, and that shown in FIG. 3C will be referred to as “data 1” and “data 2”, respectively, hereinafter.

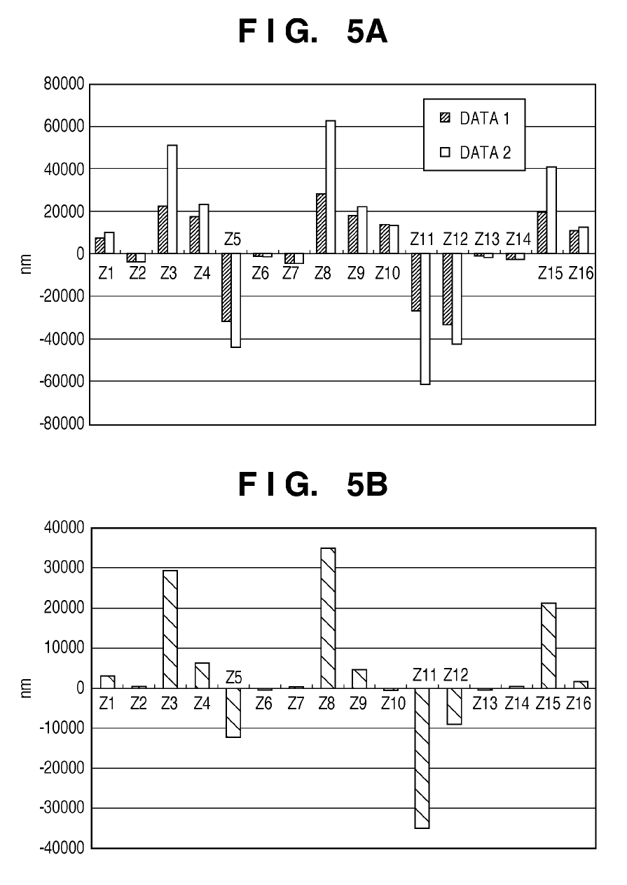

FIG. 5A shows the results of fitting the 1st to 16th terms of the 1st to 100th terms of a Zernike polynomial to data 1 and 2. FIG. 5B is a graph showing the differences between data 1 and 2 for the 1st to 16th terms shown in FIG. 5A. As shown in FIG. 5A, the Zernike polynomial has terms with Zernike coefficients of about 60 μm although both data 1 and 2 represent a shape having a PV value of about 40 nm. Also, as shown in FIG. 5B, the amount of change in the coefficient due to the presence/absence of data defect regions has a value as large as about 30 μm.

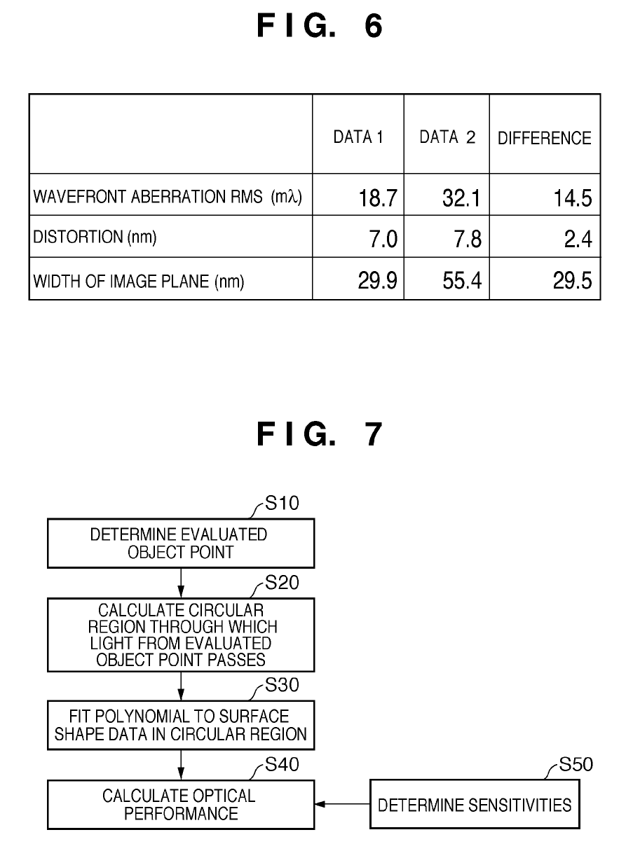

When Zernike coefficients describing the surface shape of the optical element 1 are determined, it is possible to calculate the optical performances of an optical system such as the projection optical system 7 including the optical element 1. FIG. 6 exemplifies the results of calculating the optical performances of the projection optical system 7 including the optical element 1 using Zernike coefficients describing the surface shape of the optical element 1. The optical performance of the evaluated optical system such as the projection optical system 7 can be calculated by multiplying Zernike coefficients describing the surface shape of the optical element 1 by the sensitivities of an evaluation item for the projection optical system 7 to the Zernike coefficients, and adding up the products. That is, the optical performance of the evaluated optical system can be calculated by:

Pi=Ai1×Z1+Ai2×Z2+Ai3×Z3+Ai4×Z4+Ai5×Z5+ (1)

where Pi is the optical performance of the evaluated optical system at an evaluated object point i, Z1, Z2, Z3, . . . are Zernike coefficients obtained by fitting a Zernike polynomial to the surface shape data measured by the measurement apparatus 2, and Ai1, Ai2, Ai3, . . . are the sensitivities of the optical performance of the evaluated optical system at the evaluated object point to the Zernike coefficients.

Note that evaluation items of the optical performance of the projection optical system are assumed to be the wavefront aberration RMS (the worst value among 27 points), the width of the image plane (for NA=0.86, annular illumination (outer σ=0.9 and inner σ=0.6), exposure wavelength=248 nm, a 100-nm isolated pattern, and a halftone reticle), and the distortion (a conversion value based on a deviation from the principal ray, and the 2nd and 3rd terms of the Zernike polynomial assuming that NA=0.86 and exposure wavelength=248 nm).

The results shown in FIG. 6 reveal that the differences between data 1 and 2 are errors having nearly the same values of data 1. This means that, if the shape measurement value of a noncircular measured object has a defect or an error, the error is mixed in the results of fitting a Zernike polynomial, and generates non-negligible differences in the evaluation results.

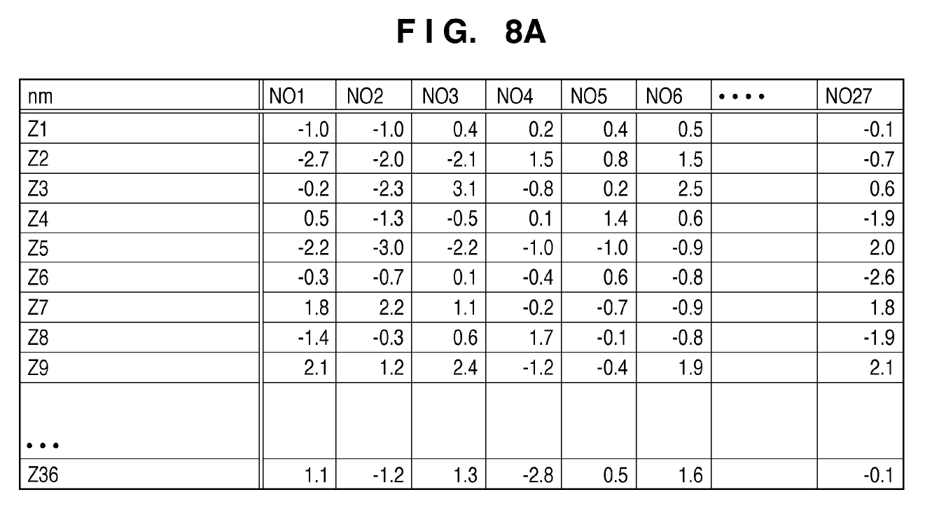

FIG. 7 is a flowchart illustrating an optical system evaluation method according to a preferred embodiment of the present invention. In this embodiment, a surface shape evaluation apparatus evaluates the surface shape of a measured object in each of a plurality of circular regions located in the evaluated region on an optical element as the measured object. This evaluation includes fitting a polynomial such as a Zernike polynomial to surface shape data in the circular regions in the evaluated region on the optical element 1 as the measured object to determine the coefficients of the polynomial. The information processing apparatus 200 calculates the overall optical performance in the evaluated region on the measured object based on the evaluation results (coefficient determination results) in the plurality of circular regions obtained by the surface shape evaluation apparatus 100. The optical system evaluation method according to the preferred embodiment of the present invention will be explained in detail below with reference to FIG. 7.

First, in step S10 (determination step), the information processing apparatus 200 determines the object points, evaluated by the surface shape evaluation apparatus 100, in an optical system such as the projection optical system 7 including the optical element 1 as the measured object. Note that the evaluated object points need to be arrayed to be able to evaluate the overall evaluated region on the optical element 1 with a required precision.

In step S20 (locating step), the information processing apparatus 200 determines by optically computing a circular region including a region in which the light beam from each evaluated object point determined in step S10 passes through the optical element 1. This means that a plurality of circular regions are located in the evaluated region on the optical element 1. At this time, if a certain region through which the light beam passes has a noncircular shape, a circular region which includes the certain region through which the light beam passes is determined. Note that one circular region is determined for each evaluated object point determined in step S10. The circular regions may or may not overlap each other.

FIG. 3B exemplifies the locations of 27 circular regions determined upon defining 27 evaluated object points in the object plane of the projection optical system 7 as the evaluated optical system. Location information representing the plurality of circular regions located in this way (for example, the center coordinates and radii of the circular regions) is sent to the surface shape evaluation apparatus 100.

In step S30, the surface shape evaluation apparatus 100 evaluates the surface shape of the optical element 1 in the individual circular regions based on the location information. Note that, in a first step, the measurement apparatus 2 measures the surface shape of the optical element 1 over the entire region including the evaluated region on the optical element 1. In a second step, the arithmetic processing unit 3 extracts, based on the location information provided by the information processing apparatus 200, surface shape data in the plurality of circular regions from the surface shape data output from the measurement apparatus 2. In a third step (fitting step), the arithmetic processing unit 3 fits a polynomial such as a Zernike polynomial to the surface shape data in each circular region to determine the coefficients of the polynomial. In a fourth step, the arithmetic processing unit 3 provides the determination results (coefficient values) obtained in the third step to the information processing apparatus 200 as the surface shape evaluation results of the optical element 1.

In step S40 (optical performance calculation step), the information processing apparatus 200 calculates the optical performance of the evaluated optical system such as the projection optical system 7 based on the evaluation result (polynomial coefficient) obtained in step S30 in each of the plurality of circular regions on the optical element 1. Examples of evaluation items of the optical performance are the wavefront aberration, the width of the image plane, and the distortion. The optical performance calculation can include multiplying the coefficients such as Zernike coefficients determined by fitting in step S30 by the sensitivities of an evaluation item for the evaluated optical system to the coefficients, and adding up the products, as in equation (1). Based on the evaluation results of the optical element as the measured object obtained at arbitrary object points in the evaluated optical system including the optical element in the above-mentioned way, the influence of the optical element exerted on the evaluated optical system can be calculated. The above-mentioned sensitivities can be determined by known optical computing in step S50 prior to step S40.

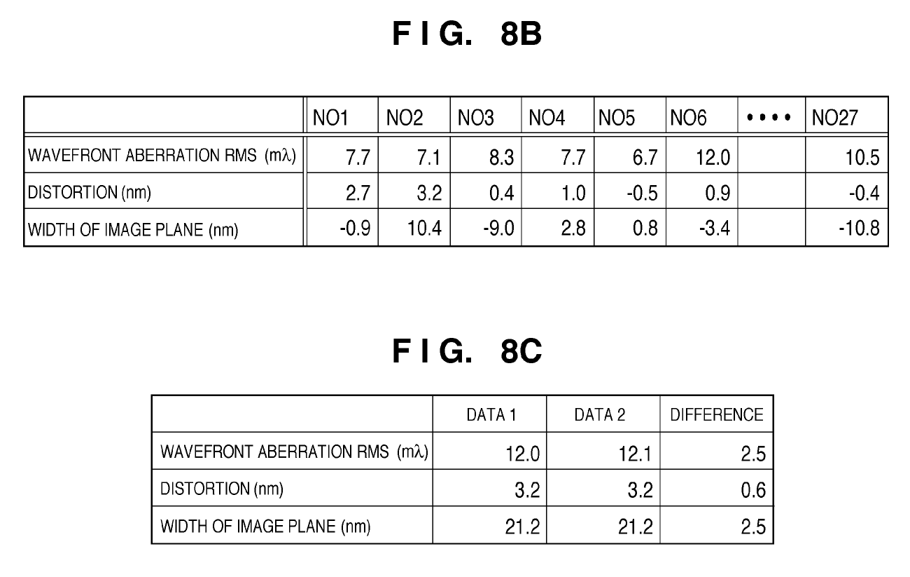

FIG. 8A is a table showing an example of the fitting results (Zernike coefficients) of a Zernike polynomial, which are obtained in step S30. FIG. 8A shows an example of the results obtained in the 27 circular regions exemplified in FIG. 3B, and NO1, . . . , NO27 indicate the numbers of the circular regions.

FIG. 8B is a table showing an example of the optical performances of the projection optical system obtained in step S40. The example shown in FIG. 8B includes the wavefront aberration RMS, the distortion, and the width of the image plane.

FIG. 8C shows the results of evaluating the optical performances at 27 points, which are shown in FIG. 8B, that is, the results of evaluating the worst values of the wavefront aberration RMSs and distortions at 27 points, and evaluating the width of the image plane in a range including 27 points. FIG. 8C reveals that the differences between data 1 and 2 have values larger than those of data 1 by an order of magnitude, unlike the results shown in FIG. 6, and therefore an error, if any, in the data is less likely to influence the evaluation.

Probable causes for this effect are, for example, that only a circular region including a data defect region is influenced by the data defect region, and that a Zernike polynomial is fitted to an orthogonalized circular region. When a Zernike polynomial is fitted to an orthogonalized circular region, the amount of amplification of errors is small even when the circular region includes a data defect region.

The reason why there are differences between the optical performances shown in FIGS. 6 and 8C for data 1 is that the results shown in FIG. 6 are obtained by evaluating the optical performance based on the result of amplifying measurement errors, whereas the results shown in FIG. 8C are obtained with a small amount of amplification of measurement errors.

Although 27 object points are evaluated in the above-mentioned example, increasing the number of object points makes it possible to evaluate the optical performance with a higher precision.

When the allowable values of the optical performances (the wavefront aberration RMS, the distortion, and the width of the image plane) evaluated previously are set as exemplified in FIG. 11, the results shown in FIG. 8C are more than the allowable values.

If the optical performance obtained in the sequence illustrated in FIG. 7 is more than the allowable value, the optical element 1 needs to be processed so that the optical performance becomes less than or equal to the allowable value, that is, so as to have a shape closer to a design shape. Note that it is hard for the conventional evaluation method to determine strategies, such as where and how to correct the surface of the optical element 1, from the optical performance, resulting in increases in the amount and time of processing. The increase in the processing amount leads to an increase in processing errors.

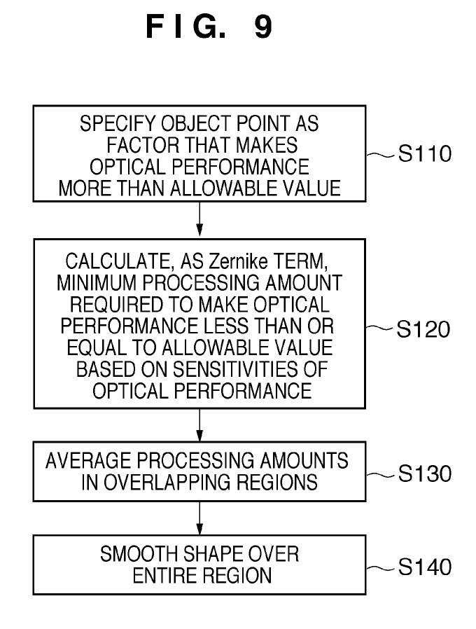

FIG. 9 is a flowchart illustrating a processing plan creation method for an optical element according to a preferred embodiment of the present invention. This method is advantageous to obtaining an optical element which satisfies a required specification (design shape) while minimizing the processing amount. This process can be executed by, for example, the information processing apparatus 200. Also, the information processing apparatus 200 which executes this process can be configured by installing a computer program on a computer.

First, in step S110 (specifying step), an object point as a factor that makes the optical performance more than the allowable value is specified. At this time, a plurality of object points may be specified. The examples shown in FIG. 8B (evaluation results) and FIG. 11 (required specification) reveal that three object points: NO2, NO6, and N027 are the factors.

In this example, in a processing amount calculation step including the following steps S120, S130, and S140, the amount of processing, to make the optical performance less than or equal to the allowable value, of a processed region corresponding to the object points specified in step S110 is determined.

More specifically, in step S120, a minimum processing amount required to make the optical performance less than or equal to the allowable value is determined as a Zernike term based on the sensitivities of the optical performance. This process is executed at each object determined in step S110.

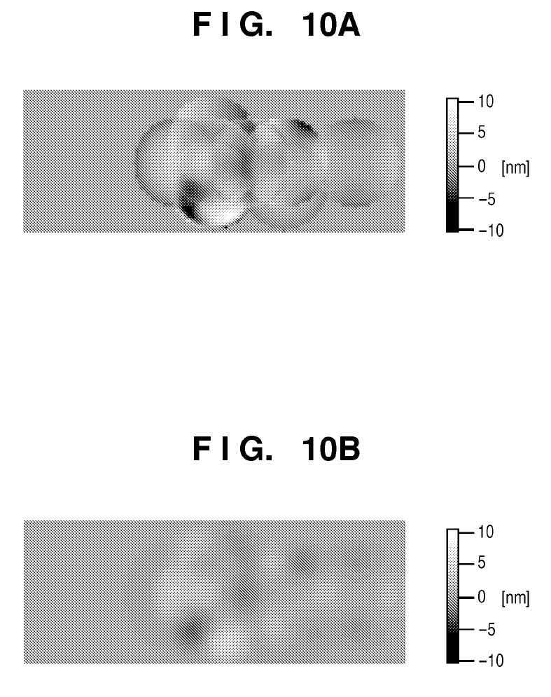

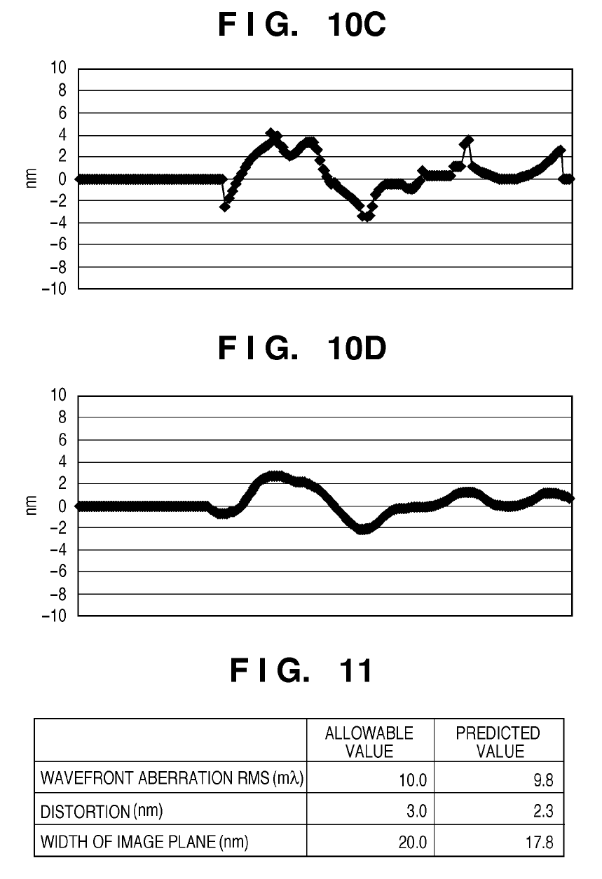

In step S130, it is determined whether the regions which require processing overlap each other. If YES in step S130, the processing amounts in the overlapping regions are averaged. FIG. 10A is a two-dimensional map exemplifying the processing amount averaged in step S130. FIG. 10C shows one section of the averaged processing amount.

In step S140, the required processing amount in the entire region on the optical element is determined by smoothing. FIG. 10B is a two-dimensional map exemplifying the processing amount smoothed in step S140. FIG. 10D shows one section of the smoothed processing amount. In other words, FIGS. 10B and 10D exemplify an additional processing amount.

Although high-frequency filtering is performed by the averaging and the smoothing in steps S130 and S140, respectively, in this example, it may be performed by other methods. In this example, the processing amount calculation step includes steps S120, S130, and S140.

An optical element manufacturing method according to a preferred embodiment of the present invention includes a processing step of processing the processed region on the optical element 1 in accordance with the processing amount calculated in the processing amount calculation step, in addition to the processing plan creation method.

In this method, only a region which receives a light beam from an object point at which the optical performance is to be improved and its periphery are an additional processed region, as exemplified in FIGS. 10A to 10D. According to this method, it is possible to manufacture an optical element which satisfies a required specification (design shape) while minimizing the processing amount. The rightmost column in FIG. 11 exemplifies the predicted values of the optical performances after the processing, and reveals that these predicted values are less than or equal to the allowable values.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-100864, filed Apr. 8, 2008, which is hereby incorporated by reference herein in its entirety.

What is claimed is:

1. A method of evaluating an optical performance of an optical system, the method comprising:
a locating step of locating a plurality of circular regions in an evaluated region on an optical element included in the optical system;
a fitting step of fitting a polynomial to surface shape data representing a surface shape of the optical element in each of the plurality of circular regions; and
a calculation step of calculating the optical performance of the optical system based on the fitting result obtained in the fitting step in each of the plurality of circular regions.

2. The method according to claim 1, wherein
the fitting result includes a determination result of a coefficient of the polynomial, and
the calculation in the calculation step includes multiplying the coefficient by a sensitivity of the optical performance to the coefficient.

3. The method according to claim 1, further comprising a determination step of determining a plurality of object points in the optical system as evaluated object points,
wherein in the locating step, the plurality of circular regions are located such that one circular region includes a region in which light coming from one object point determined in the determination step passes through the optical element.

4. The method according to claim 1, wherein the polynomial includes a Zernike polynomial.

5. A method of creating a processing plan for an optical element included in an optical system, the method comprising:
a determination step of determining a plurality of object points in the optical system as evaluated object points;
a locating step of locating a plurality of circular regions in an evaluated region on the optical element such that one circular region includes a region in which light coming from one object point determined in the determination step passes through the optical element;
a fitting step of fitting a polynomial to surface shape data representing a surface shape of the optical element in each of the plurality of circular regions;
an optical performance calculation step of calculating an optical performance of the optical system based on the fitting result obtained in the fitting step in each of the plurality of circular regions;
a specifying step of specifying an object point at which the optical performance calculated in the calculation step is more than an allowable value; and
a processing amount calculation step of calculating an amount of processing, to make the optical performance not more than the allowable value, of a processed region corresponding to the object point specified in the specifying step in the evaluated region on the optical element.

6. A method of evaluating a surface shape of a measured object, the method comprising:
an extraction step of extracting surface shape data in a plurality of circular regions from surface shape data representing a surface shape of the measured object in an evaluated region; and
a fitting step of fitting a polynomial to the surface shape data in the plurality of circular regions extracted in the extraction step.

7. A method of manufacturing an optical element included in an optical system, the method comprising:
a determination step of determining a plurality of object points in the optical system as evaluated object points;
a locating step of locating a plurality of circular regions in an evaluated region on the optical element such that one circular region includes a region in which light coming from one object point determined in the determination step passes through the optical element;
a fitting step of fitting a polynomial to surface shape data representing a surface shape of the optical element in each of the plurality of circular regions;
an optical performance calculation step of calculating an optical performance of the optical system based on the fitting result obtained in the fitting step in each of the plurality of circular regions;
a specifying step of specifying an object point at which the optical performance calculated in the calculation step is more than an allowable value;
a processing amount calculation step of calculating an amount of processing, to make the optical performance not more than the allowable value, of a processed region corresponding to the object point specified in the specifying step in the evaluated region on the optical element; and
a processing step of processing the processed region in accordance with the processing amount calculated in the processing amount calculation step.

8. A memory medium storing a computer program for making a computer execute a method of evaluating an optical performance of an optical system, the method comprising:
a locating step of locating a plurality of circular regions in an evaluated region on an optical element included in the optical system;
a fitting step of fitting a polynomial to surface shape data representing a surface shape of the optical element in each of the plurality of circular regions; and
a calculation step of calculating the optical performance of the optical system based on the fitting result obtained in the fitting step in each of the plurality of circular regions.

9. A memory medium storing a computer program for making a computer execute a method of creating a processing plan for an optical element included in an optical system, the method comprising:
a determination step of determining a plurality of object points in the optical system as evaluated object points;
a locating step of locating a plurality of circular regions in an evaluated region on the optical element such that one circular region includes a region in which light coming from one object point determined in the determination step passes through the optical element;
a fitting step of fitting a polynomial to surface shape data representing a surface shape of the optical element in each of the plurality of circular regions;
an optical performance calculation step of calculating an optical performance of the optical system based on the fitting result obtained in the fitting step in each of the plurality of circular regions;
a specifying step of specifying an object point at which the optical performance calculated in the calculation step is more than an allowable value; and
a processing amount calculation step of calculating an amount of processing, to make the optical performance not more than the allowable value, of a processed region corresponding to the object point specified in the specifying step in the evaluated region on the optical element.

10. A memory medium storing a computer program for making a computer execute a method of evaluating a surface shape of a measured object, the method comprising:
an extraction step of extracting surface shape data in a plurality of circular regions from surface shape data representing a surface shape of the measured object in an evaluated region; and
a fitting step of fitting a polynomial to the surface shape data in the plurality of circular regions extracted in the extraction step.
